(19) United States
(12) Patent Application Publication
(10) Pub. No.: US 2025/0271919 A1
(43) Pub. Date: Aug. 28, 2025

(54) ELECTRIC POWER ADJUSTMENT DEVICE

(71) Applicant: HITACHI, LTD., Tokyo (JP)

(72) Inventors: Tetsuya ISHIMARU, Tokyo (JP); Akio SHIMA, Tokyo (JP); Yoshiaki TOYOTA, Tokyo (JP)

(21) Appl. No.: 18/858,799

(22) PCT Filed: May 10, 2023
(86) PCT No.: PCT/JP2023/017599

§ 371 Date: Oct. 22, 2024

(30) Foreign Application Priority Data
May 26, 2022 (JP) 2022-086083

(51) Int. Cl. G06F 1/3206; F24F 11/47; F24F 140/60; G06F 1/20; G06F 1/324; G06F 1/3296; H05K 7/20

(52) U.S. Cl. CPC G06F 1/3206; F24F 11/47; G06F 1/206; G06F 1/324; G06F 1/3296; H05K 7/20745; F24F 2140/60; G06F 2200/201

(57) ABSTRACT

To provide an electric power adjustment device having adjustment capability for frequency fluctuation of an electric power system without newly introducing expensive facility and without executing useless electric power adjustment in the present invention. An electric adjustment device of the present invention calculates adjustment amounts of a computer group or air conditioner devices on the basis of frequency fluctuations in an electric power system, and determines an adjustment object for electric power consumption from among workloads executed by the computer group or air conditioner devices on the basis of the adjustment amounts.

### TECHNICAL FIELD

The present invention relates to a technology of adjustment of electric power consumption of a computer group or an air conditioner device.

### BACKGROUND ART

Toward the achievement of carbon neutrality in 2050, each country is making progress in reducing greenhouse gas emissions. During that, installation of generators using renewable energy such as solar power and wind power is rapidly increasing. When a large number of the solar power generations and wind power generations, which are largely time-varying in power generation amount, are coupled to an electric power system, the power supply demand imbalance of the electric power system occurs and the risk that power fluctuation of the electric power system occurs increases. As a result of the power fluctuation, fluctuation of frequency and voltage occurs. In the past, the power fluctuation of the electric power system is suppressed using synchronous generators using, e.g., thermal power.

Technologies of suppressing the power fluctuation by use of the synchronous generators using, e.g., thermal power, particularly suppressing the frequency fluctuation, include governor-free, Load Frequency Control (LPF), and Economic Load Dispatching (ELD). The governor-free is such that, by operating a governor (governor) provided to a turbine of a generator to change an output of the generator in response to fluctuation of a system frequency, the frequency of the system is kept constant for a short fluctuation period from several tens of seconds to several minutes. The LPF is such that, a load fluctuation amount is calculated at a central load dispatching center, and by commanding a power generation amount following this load fluctuation amount to each generator, a system frequency falls within an acceptable range relative to a fluctuation of about several minutes to twenty minutes. The ELD is such that, in consideration of economy of a generator, an output distribution for each thermal generator is determined in response to a required power generation amount to suppress a long fluctuation of over several tens of minutes. In the future, toward carbon neutrality, the number of thermal generators is reduced, and the adjustment capability for frequency fluctuations by generators are thought to be reduced. In Japan, to secure adjustment capabilities that are running short, supply and demand adjustment markets for trading adjustment capabilities for frequency adjustment and supply and demand adjustment are gradually starting from 2021 to 2024.

As adjustment capabilities instead of thermal generators, storage batteries start being used with decrease in prices of the storage batteries. Patent Literature 1 describes a method of determining control content of storage batteries based on a frequency of an electrical power system by using the storage batteries to suppress fluctuation of frequency fluctuation of the electric power system.

Patent Literature 2 describes a technology of adjusting calculation loads in a computer system to optimize the electric power generated by an energy source (see the Abstract). The same Literature describes that, as a technology of electric power adjustment using the data center, power consumption of the data center is adjusted in response to fluctuation of the output voltage of fluctuating solar power generation by use of optimum power point tracking to optimize energy generation efficiency.

### CITATION LIST

### Patent Literature

Patent Literature 1: Japanese Unexamined Patent Application Publication No. 2018-093573
Patent Literature 2: Japanese Unexamined Patent Application Publication (Translation of PCT Application) No. 2014-502389

### SUMMARY OF INVENTION

### Technical Problem

When storage batteries are used to adjust frequency fluctuation of an electric power system (Example: Patent Literature 1), the storage batteries are expensive and the cost for adjustment capability becomes high. When distributed power supply such as solar power generation and wind power generation becomes popular, installation of microgrids that execute stabilization control of the system for each area progresses, and more adjustment capabilities are thought to become necessary. When the adjustment capabilities for frequency fluctuation in all the microgrids use storage batteries, the cost for forming the microgrids becomes high to prevent spread of the microgrids.

An objective of a technology described in Patent Literature 2 is not to prevent fluctuation of output voltage of solar power generation, wherein a method of preventing fluctuation of the output voltage of the solar power generation is not described. Additionally, a method of suppressing electric power fluctuation and frequency fluctuation of an electric power system is not described at all. Further, a possibility that unnecessary excessive adjustment of power consumption of a data center is made is thought.

The present invention has been made in view of the above problem, and has an objective to provide an electric power adjustment device having adjustment capability for frequency fluctuation of an electric power system without newly introducing expensive facility and without executing useless electric power adjustment.

### Solution to Problem

An electric adjustment device of the present invention calculates adjustment amounts of a computer group or air conditioner devices on the basis of frequency fluctuations in an electric power system, and determines an adjustment object for electric power consumption from among workloads executed by the computer group or air conditioner devices on the basis of the adjustment amounts.

### Advantageous Effects of Invention

According to the electric adjustment device of the present invention, the electric power adjustment device having adjustment capability for frequency fluctuations of the electric power system without introducing new expensive facility and without executing useless electric power adjustment.

### BRIEF DESCRIPTION OF DRAWINGS

FIG. 1 is a configuration diagram of an electric power adjustment device 100 of First Embodiment.

FIG. 2 illustrates one example of a workload list 110.

FIG. 3 illustrates droop characteristics used to derive an electric power consumption adjustment amount.

FIG. 4 illustrates one example of an air conditioning list 112.

FIG. 5 illustrates one example of the air conditioning list 112.

FIG. 6 illustrates the updated workload list 110 during execution of electric power adjustment.

FIG. 7 is an example of the air conditioning list 112 after electric power consumption is adjusted.

FIG. 8 illustrates temporal changes of frequency of an electric power system when the electric current adjustment of First Embodiment is not executed and when the electric current adjustment of First Embodiment is executed.

FIG. 9 illustrates a configuration diagram of the electric power adjustment device 100 of Second Embodiment.

FIG. 10 illustrates one example of a relationship between a server electric power consumption adjustment amount and a clock frequency.

FIG. 11 illustrates the updated workload list 110 during execution of electric power adjustment.

FIG. 12 illustrates one example of a relationship between a server electric power consumption adjustment amount and a CPU drive voltage.

FIG. 13 illustrates a configuration diagram of the electric power adjustment device 100 of Second Embodiment.

### DESCRIPTION OF EMBODIMENTS

### First Embodiment

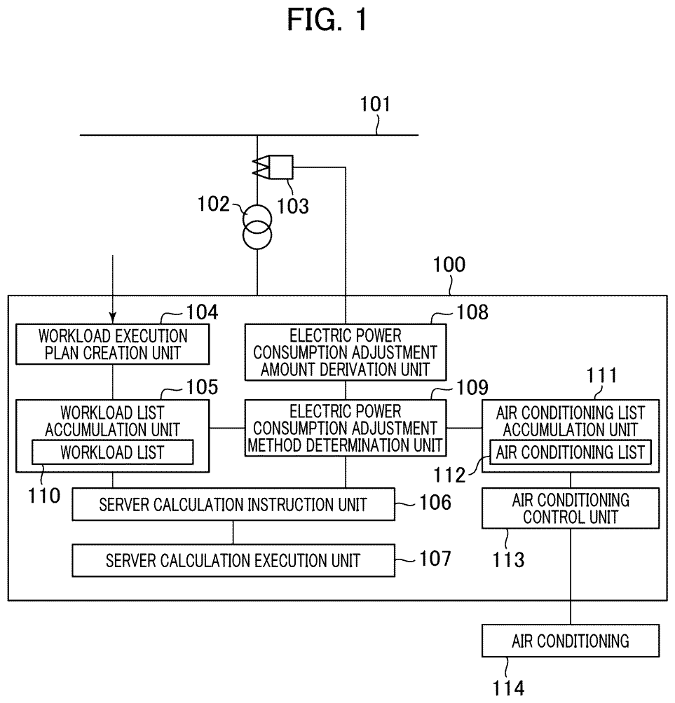

FIG. 1 illustrates a configuration diagram of an electric power adjustment device 100 of First Embodiment of the present invention. The electric power adjustment device 100 is installed, e.g., in a data center containing a computer group, and adjusts electric power consumption of the computer group and the air conditioning device in the data center. The electric power adjustment device 100 (and the computer group and the air conditioners in the data center) is connected to an electric power system 101 (hereinafter may be called a “system 101”) via a transformer 102 and a distribution line.

The electric power adjustment device 100 includes a workload execution plan creation unit 104, a workload list accumulation unit 105, a server calculation instruction unit 106, a server calculation execution unit 107, an electric power consumption adjustment amount derivation unit 108, an electric power consumption adjustment method determination unit 109, an air conditioning list accumulation unit 111, and an air conditioning control unit 113. The workload list accumulation unit 105 accumulates a workload list 110. The air conditioning list accumulation unit 111 accumulates an air conditioning list 112 an air conditioner device (hereinafter may be called just an air conditioner) 114 is installed in the data center, and used for cooling the computer group in the data center. The air conditioner 114 is connected to the air conditioning control unit 113.

The system 101 is a distribution line to which high voltage power is supplied from an electric power substation. For example, alternating current power of 50 Hz, 6.6 kV is supplied. The transformer 102 is a voltage converter that converts high voltage alternating current power to low voltage alternating current power. For example, alternating current power of 50 Hz, 6.6 kV of the system 101 is converted to low voltage alternating current power of 50 Hz, 200 V, and supplied to the data center. When the electric power adjustment device 100 is driven by direct current power, an AC-DC converter that converts alternating current power of the system 101 to direct current power is used in the transformer 102. A frequency measurement unit 103 is attached to the system 101, and measures frequency of alternating current power of the system 101. The measurement of frequency can be executed by acquiring time-series data of voltage of the system 101 and Fourier transforming the time-series data of voltage.

Execution of a workload in the electric power adjustment device 100 is explained. The workload is a calculation load executed by the computer group contained in the data center. A user of the data center requests the data center to execute the calculation load by paying the price. The workload execution plan creation unit 104 plans execution of the workloads in the data center on the basis of a list of the workloads, the list being provided to the electric power adjustment device 100. The workload execution plan is added and updated in the workload list 110 accumulated in the workload list accumulation unit 105.

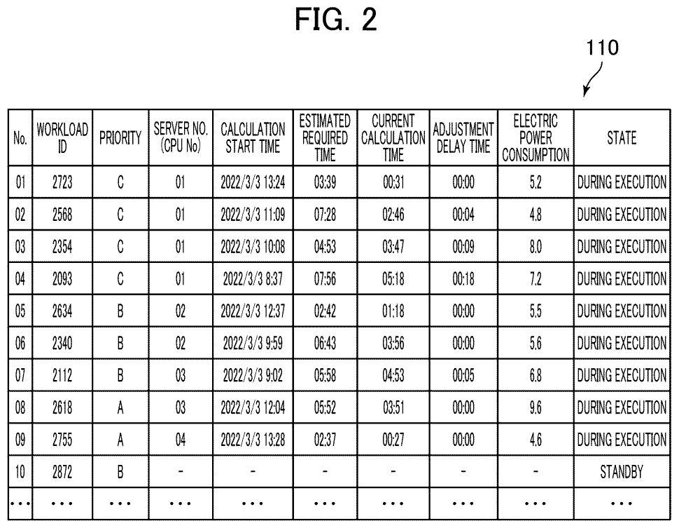

FIG. 2 illustrates one example of the workload list 110. The example illustrated in FIG. 2 is the workload list when the after-mentioned electric power consumption adjustment is not made. No. 10 (workload ID 2872) in the list illustrated in FIG. 2 is a newly populated workload before execution. The newly populated workload for the electric power adjustment device 100 is assigned a workload ID and a priority, and added to the workload list 110. The priority is predetermined by negotiation with the user who populates the workload. For example, A has high priority and is not used for electric power consumption adjustment, B has high priority and is used for electric power consumption adjustment when no other workload used for electric power consumption is present, and C has low priority and is actively used for electric power consumption adjustment. The priority is reflected in fee calculation, and the user who has selected low priority may be given cost benefit. The newly populated workload before execution is set as “standby” in the state column.

Then, the server calculation instruction unit 106 executes the standby workload in the workload list 110. The data center usually contains multiple server computers, and the workloads having the same priority are executed by the same server to the extent possible. This is because the after-mentioned electric power consumption adjustment can be easily made. With start of the execution of the workload, the server calculation instruction unit 106 inputs a used server, a calculation start time, and an estimated required calculation time, and sets the state column as “during-execution.” The estimated required time is not necessarily required, and is estimated using content of the workload and the used server. During the execution of the workload, the current calculation time and electric power consumption of the workload list 110 are periodically updated (for example, every five minutes). An adjustment delay time is a time of delay of calculation due to the after-mentioned electric power consumption adjustment. At the execution start of the workload, the adjustment delay time is set to zero, and the delay time is estimated when the electric power consumption adjustment is executed, and that time is added. The electric power consumption is electric power consumption of the server for each workload. The server calculation instruction unit 106 determines this from the electric power consumption of the server that is executing the workload and a calculation load of the server for the workload. When the electric power consumption for each workload cannot be grasped, a value estimated using some kind of method may be used.

The workloads of the workload list 110 are aligned in the order of selecting the workload used for adjustment of the electric power consumption. In the example of FIG. 2, the workloads during execution are in the higher ranks. Next, the workloads are in descending order of priorities C, B, A. Lastly, the workloads are in order from lower to higher in percentage of the adjustment delay time relative to the current calculation time. The order from lower to higher in percentage of the adjustment delay time relative to the current calculation time corresponds to the order from lower to higher in execution rate of the electric power consumption adjustment. As a reference of selecting the order of selecting the workload, the estimated required time may be used. For example, the selection order for the workload in which the current calculation time is over the estimated required time is lowered.

Lastly, on the basis of the instruction of the workload execution outputted by the server calculation instruction unit 106, the server calculation execution unit 107 including a CPU (Central Processing Unit), a memory, a hard disk, etc. executes calculations of the workloads.

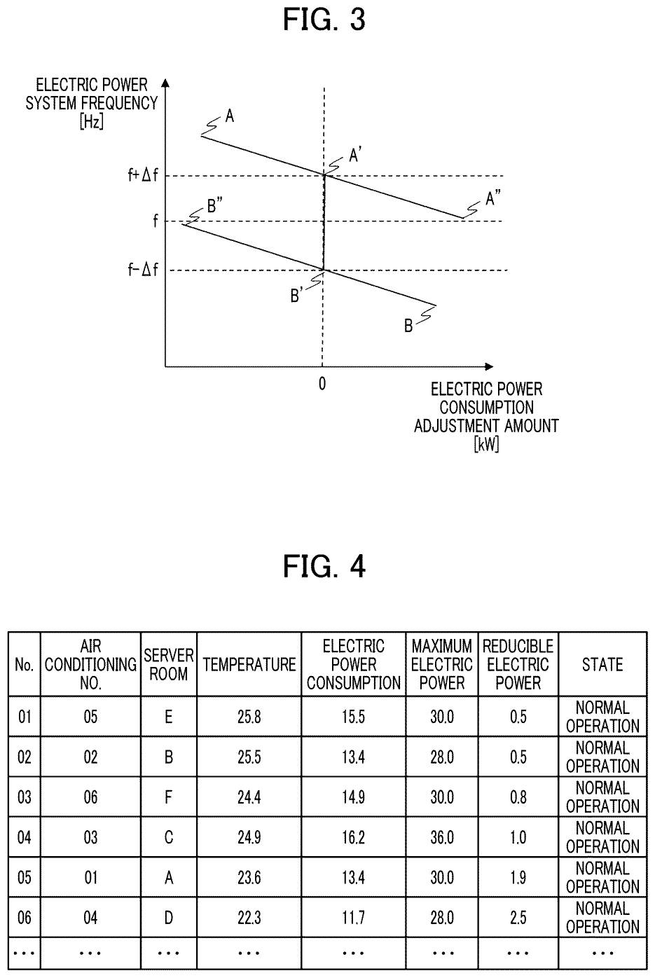

FIG. 3 illustrates droop characteristics used to derive the electric power consumption adjustment amount. By use of FIG. 3, execution of the electric power consumption adjustment in the electric power adjustment device 100 is explained. The electric power consumption adjustment amount derivation unit 108 derives the electric power consumption adjustment amount by use of frequency of the system 101 measured by the frequency measurement unit 103. On the graph of FIG. 3, the vertical axis indicates the frequency of the system 101, and the horizontal axis indicates the electric power consumption adjustment amount. Multiple lines are present on the graph. (a) When the electric power consumption adjustment is not executed, the droop characteristics having an offset of B-B′-A′-A are used. (b) When the electric power consumption adjustment that reduces electric current consumption is executed, the droop characteristics not having an offset of A-A″ are used. (c) When the electric power consumption adjustment that increases electric current consumption is executed, the droop characteristics not having an offset of B-B″ are used. The offset is provided in the range of the frequency f±Δf of the system 101 on the vertical axis. The f is reference frequency of the system 101 (for example, 50 Hz). The Δf is a frequency fluctuation width of the system 101 in which the electric power adjustment device 100 does not adjust electric power consumption (hereinafter called a non-adjustment frequency fluctuation width, for example, ±0.18 Hz). The non-adjustment frequency fluctuation width Δf is smaller than a frequency fluctuation width acceptable by the system 101 (hereinafter, called an acceptable frequency fluctuation width, for example, ±0.2 Hz), and is set so that the frequency of the system 101 does not exceed the acceptable frequency fluctuation width even when the electric power consumption adjustment is executed. With setting of the offset, when the frequency of the system 101 fluctuates but does not exceed the range f±Δf of the frequency of the offset, the electric power consumption adjustment amount becomes zero, and the electric power consumption adjustment is not executed. Therefore, with the setting of the offset, unnecessary electric power consumption adjustment does not need to be executed.

When the frequency of the system 101 rises and exceeds the offset range f±Δf, the electric power consumption adjustment amount becomes greater in the negative direction (in the left direction on the horizontal axis of the graph) as the frequency of the system 101 rises. The negative means adjustment in the direction of reducing the electric power consumption. The characteristics of decreasing toward the right are called droop characteristics, and a control using the droop characteristics is called a droop control. The slope of a negative straight line is called a droop factor. The droop factor is set as an adequate magnitude to enable suppression of fluctuation of the frequency of the system 101. With the control using this droop characteristics, the fluctuation of the frequency of the system 101 over the non-adjustment frequency fluctuation width Δf can be suppressed. When the frequency of the system 101 decreases and becomes less than the offset range f-Δf, the electric power consumption adjustment amount becomes greater in the positive direction (the right direction of the horizontal axis on the graph). The positive means adjustment in the direction of increasing the electric power consumption. As well as in the negative, the fluctuation of the frequency of the system 101 over the non-adjustment frequency fluctuation width Δf can be suppressed. With respect to the droop characteristics, the data describing the definition such as FIG. 3 may be previously stored in a storage device provided in the electric power adjustment device 100.

Subsequently, the electric power consumption adjustment method determination unit 109 determines an adjustment method for power consumption when the electric power consumption adjustment amount derived by the electric power consumption adjustment amount derivation unit 108 is not zero. When the adjustment method for electric power consumption is determined, the electric power consumption adjustment amount, the workload list 110, and the air conditioning list 112 are used. The electric power consumption adjustment method is varied in the cases: (a) when the electric power consumption adjustment is not being executed: (b) when the electric power consumption adjustment that reduces electric current consumption is being executed: (c) when the electric power consumption adjustment that increases electric current consumption is being executed: (d) when the electric power consumption adjustment amount is negative; and (e) when the electric power consumption adjustment amount is positive. In the following, each case is explained.

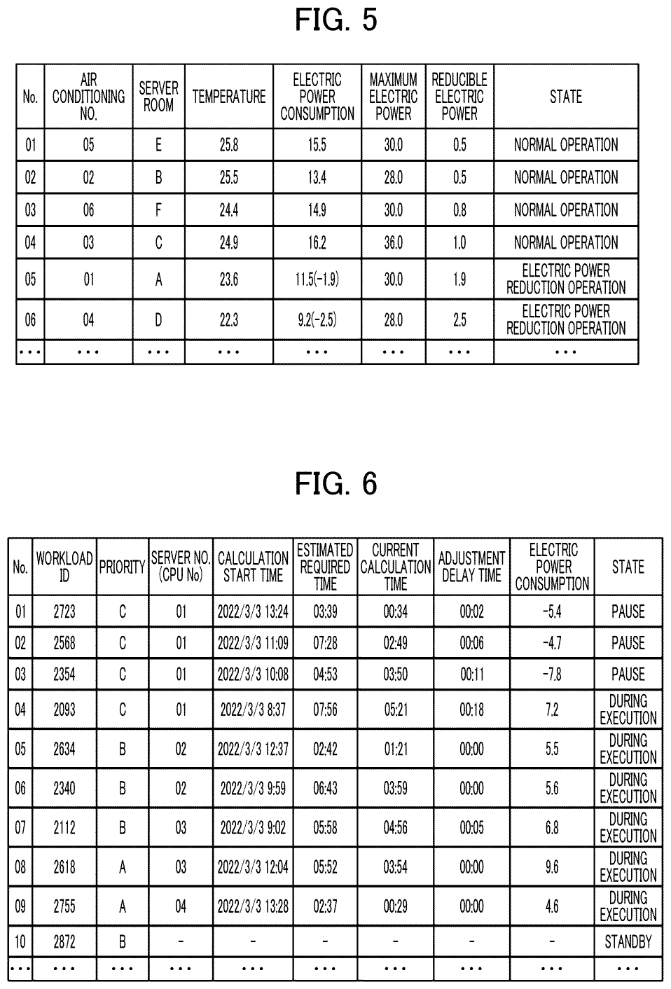

FIGS. 4 and 5 illustrate one example of the air conditioning list 112. (a) When the electric power consumption adjustment is not executed, and (d) when the electric power consumption adjustment amount is negative, the electric power consumption of the air conditioning 114 in the data center is first reduced as the electric power consumption adjustment. When the air conditioning used for the electric power consumption adjustment is determined, the air conditioning list 112 is used. An installation server room, a temperature, electric power consumption, the maximum electric power, reducible electric power, and a state are inputted into the air conditioning list 112 for each air conditioning device. The reducible electric power is a difference between a current electric power consumption of the air conditioning device and electric power consumption of the air conditioning device required to keep the upper limit temperature (for example, 27° C.) in the server room. The electric power consumption required to keep the upper limit temperature (for example, 27° C.) in the server room is derived by preparing a derivation equation as a function of an outside temperature and electric power consumption of a server for each air conditioning and by using this equation. FIG. 4 illustrates an example of data before execution of the electric power consumption adjustment, and FIG. 5 illustrates an example of data after execution of the electric power consumption adjustment.

As a method of determining air conditioning used for the electric power consumption adjustment, reduction of the electric power consumption of the air conditioning for a server room whose temperature is a reference temperature or below (reduction of the air conditioning capability) can be thought, for example. When the reference temperature is 24° C., No. 05 and No. 06 are selected in FIG. 4. When the electric power consumption adjustment amount is 20 kW, the air conditioning control unit 113 instructs the air conditioning 114 to reduce the electric power consumptions of No. 05 and No. 06 by the reducible electric power. The air conditioning 114 adjusts the electric power consumptions according to the instruction. As illustrated in FIG. 5, after the electric power consumption is adjusted, the reduction of the electric power consumption is added to the electric power consumption column of the air conditioning list 112, and the column of the state of the air conditioning list 112 is changed from normal operation into electric power reduction operation. When the electric power consumption adjustment amount can be covered with the electric power consumption adjustment of the air conditioning, the electric power consumption adjustment ends here. Here, the temperature of the air conditioning of the server room is used for the determination of the air conditioning used for the electric power consumption adjustment. The temperature in the server body and the temperature of a rack in which the server is stored may be used.

In this example, since the electric power consumption adjustment amount is 20 kW, and the electric power consumption adjustment amount by the air conditioning is 4.4 kW, the electric power consumption of the remaining 15.6 kW needs to be reduced. Therefore, more electric power consumption of the server is reduced. When the adjustment method for the electric power consumption of the server is determined, the workload list 110 is used. The sum of the electric power consumptions are calculated in order from the higher to lower workloads of the workload list 110. The workloads in which the sum of the electric power consumptions becomes more than the electric power consumption adjustment amount are selected as workloads used for the electric power consumption adjustment (hereinafter called electric power consumption adjustment workloads). Specifically, when the remaining electric power consumption adjustment amount is 15.6 kW in the list illustrated in FIG. 2, the sum of the electric power consumptions of No. 1 to No. 3 at higher ranks in the list becomes 18 kW to exceed the electric power consumption adjustment amount. Therefore, No. 1 to No. 3 are set as the electric power consumption adjustment workloads.

In response to the determination of the electric power consumption adjustment method determination unit 109, the server calculation instruction unit 106 transmits, to the server calculation execution unit 107, an instruction that pauses the workload adjusting the electric power consumption. The server calculation execution unit 107 pauses the electric power consumption adjustment workload during execution. After the pause, the server calculation instruction unit 106 updates the workload list 110.

FIG. 6 illustrates the updated workload list 110 during execution of electric power adjustment. In response to the information from the server calculation instruction unit 106, the server calculation execution unit 107 changes the column of the state of the workload list 110 from during-execution to pause correspondingly to the electric power consumption adjustment workload. Additionally, the reduction amount of the electric power consumption acquired as a result of the electric power consumption adjustment is inputted into the column of the electric power consumption of the workload list 110.

(a) When the electric power consumption adjustment is not executed and (e) when the value of the electric power consumption adjustment amount is positive, the electric power consumption adjustment method determination unit 109 selects the workload whose state column indicates standby from the higher ranks in the workload list 110, and instructs the server calculation instruction unit 106 (or the server calculation execution unit 107 directly) to execute the workload. When a space capacity to execute the workload exists on the server, the server calculation execution unit 107 newly executes that workload. When the sum of the electric power consumptions of the workloads newly executed for the electric power consumption adjustment amount does not exceed the absolute value of the electric power consumption adjustment amount, the standby workload is newly executed in the similar manner. When the sum of the electric power consumptions of the workloads newly executed for the electric power consumption adjustment amount exceeds the absolute value of the electric power consumption adjustment amount, the electric power consumption adjustment is finished.

When the sum of the electric power consumptions of the newly executed workloads does not exceed the absolute value of the electric power consumption adjustment amount, when there is no standby workload, or when there is no space capacity to execute the workload in the server, the electric power consumption of the air conditioning 114 may be increased. When the air conditioning 114 used for the electric power consumption adjustment is determined, the air conditioning list 112 is used. As a method of determining the air conditioning used for the electric power consumption adjustment, the air conditioning in which the temperature in the server room is more than the reference temperature is selected. In case of the air conditioning list 112 illustrated in FIG. 4, when the reference temperature is 24° C., the air conditionings of No. 01 to No. 04 are selected. The air conditionings are selected not to exceed the maximum electric power consumption by the increase in electric power consumption. In case of excess, the corresponding air conditioning is not selected. When there is no air conditioning that exceeds the reference temperature, the reference temperature is lowered and the air conditioning is selected. When the remaining electric power consumption adjustment amount is 8 kW, the air conditioning control unit 113 instructs the air conditioning 114 to increase the electric power consumption by 2 kW equally by use of four air conditionings of No. 01 to No. 04. The air conditioning 114 adjusts the electric power consumption according to the instruction.

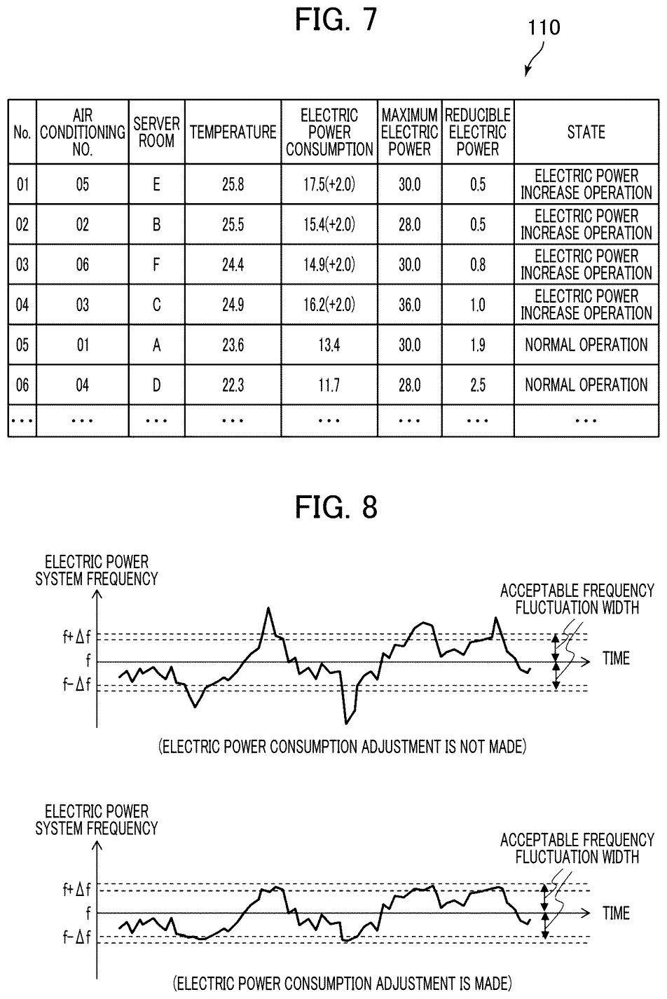

FIG. 7 is an example of the air conditioning list 112 after electric power consumption is adjusted. As illustrated in FIG. 7, the increased electric power consumption is added to the column of the electric power consumption. The column of the state is changed from normal operation to electric power increase operation. The excessive cooling of the air conditioning due to the increase in electric power consumption by this electric power consumption adjustment is recovered by reducing the electric power consumption of the air conditioner when the adjustment of the electric power consumption is unnecessary.

(b) When the electric power consumption adjustment that reduces the electric power consumption is executed, the droop characteristics of A-A″ illustrated in FIG. 3 are used. When the electric power consumption adjustment amount derived from the system 101 by use of the droop characteristics of A-A″ is zero, the electric power consumption adjustment is continued without changing the electric power consumption adjustment amount.

(d) When the value of the electric power consumption adjustment amount is negative, the electric power consumption adjustment that reduces the electric power consumption is added. First, when there is the air conditioning below the reference temperature in reference to the air conditioning list 112, the electric power consumption of the air conditioning 114 is reduced using the same method as above. When the electric power consumption adjustment cannot be reduced by the air conditioning 114, the workload is paused using the same method as above in reference to the workload list 110 to reduce the electric power consumption of the server. For example, with respect to the workload list 110 on which the electric power consumption adjustment that reduces the electric power consumption illustrated in FIG. 6 is during execution, when the electric power consumption adjustment amount is 10 KW, the during-execution higher workloads in which the sum of the electric power consumptions exceeds 10 KW, that is, the workloads of No. 4 and No. 5 set as additional electric power consumption adjustment workloads. In response to the instruction of the server calculation instruction unit 106, the server calculation execution unit 107 pauses the additional electric power consumption adjustment workloads. After the pause, the workload list 110 is updated using the same method as above.

(e) When the electric power consumption adjustment amount is positive, the electric power consumption adjustment that increases the electric power consumption is executed. For example, about the workload list 110 that is executing the electric power consumption adjustment to reduce the electric power consumption illustrated in FIG. 4, when the electric power consumption adjustment amount is-10 KW (that is, when the adjustment that reduces the electric power consumption is during execution), the paused lower rank workloads in which the sum of the electric power consumptions during adjustment exceeds-10 KW as the absolute value, that is, the electric power consumption adjustment of the workloads of No. 02 and No. 03 is stopped. The server calculation instruction unit 106 transmits, to the server calculation execution unit 107, an instruction that re-executes the workloads in which the electric power consumption adjustments are stopped. The server calculation execution unit 107 re-executes the workloads in which the electric power consumption adjustments are stopped. After the re-execution, in response to information from the server calculation instruction unit 106, the server calculation instruction unit 106 changes the column of the state of the workload list 110 from pause to during-execution with respect to the workloads during re-execution, and inputs the electric power consumptions into the column of the electric power consumption of the workload list 110. In the execution of the electric power consumption adjustment that increases the electric power consumption, when the sum of the electric power consumptions of all the paused workloads, the electric power consumptions being during adjustment, does not exceed the electric power consumption adjustment amount, all the paused workloads are re-executed. When there is still the remaining of the electric power consumption adjustment amount, and when the air conditioning list 112 includes the air conditioning in the electric power reduction operation, the air conditioning is returned to the normal operation. When all the paused workloads are re-executed and the air conditioning is returned to the normal operation, a further adjustment is not executed, and the electric power consumption adjustment ends. After that, (a) the electric power consumption adjustment is executed using the droop characteristics B-B′-A′-A when the electric power consumption adjustment is not executed.

(c) When the electric power consumption adjustment that increases the electric power consumption is executed, the droop characteristics of B-B″ illustrated in FIG. 3 are used. When the electric power consumption adjustment amount derived from the system 101 by use of the droop characteristics of B-B″ is zero, the electric power consumption adjustment is continued without changing the electric power consumption adjustment amount.

(e) When the value of the electric power consumption adjustment amount is positive, the electric power consumption adjustment that increases the electric power consumption is added. With the same method as when the above electric power consumption adjustment is not executed, the electric power consumption adjustment that increases the electric power consumption is executed. The workloads with the state column indicating standby are selected from the higher rank of the workload list 110. The server calculation instruction unit 106 instructs the server calculation execution unit 107 to execute the selected workloads. When the server has a space to execute a workload, the server calculation execution unit 107 newly executes the workloads. When the sum of the electric power consumptions of the workloads newly executed for the electric power consumption adjustment amount does not exceed the absolute value of the electric power consumption adjustment amount, the standby workload is newly executed in the similar manner. When the sum of the electric power consumptions of the workloads newly executed for the electric power consumption adjustment amount exceeds the absolute value of the electric power consumption adjustment amount, the electric power consumption adjustment is finished. When there is no standby workload or when there is no space to execute the workload in the server, the electric power consumption of the air conditioning 114 is increased as the electric power consumption adjustment. As well as in the above method, the air conditioning more than the reference temperature is selected, and the electric power consumption adjustment that increases the electric power consumption is executed. The air conditioning 114 that exceeds the reference temperature due to the electric power consumption adjustment already executed to increase the electric power consumption is not selected. By setting the reference temperature as a reference for air conditioning selection, the electric power consumption adjustment can be executed in the range not exceeding the upper limit temperature of the server room.

(d) When the electric power consumption adjustment amount is negative, the electric power consumption adjustment that reduces the electric power consumption is executed. When the air conditioning of electric power increase operation is present in the air conditioning list 112, an increment of the electric power consumption is reduced from the air conditioning having a large increment of the electric current consumption (numerals in the parentheses of the column of the electric power consumption of FIG. 7) by the electric power consumption adjustment amount. When all the increment is reduced, a further adjustment is not executed, and the electric power consumption adjustment ends. After that, (a) the electric power consumption adjustment is executed using the droop characteristics B-B′-A′-A when the electric power consumption adjustment is not executed.

FIG. 8 illustrates temporal changes of frequency of an electric power system when the electric current adjustment of First Embodiment is not executed and when the electric current adjustment of First Embodiment is executed. The upper of FIG. 8 illustrates the frequency of the electric power system in the case where the electric current consumption adjustment is not executed, and the lower of FIG. 8 illustrates the frequency of the electric power system in the case where the electric power consumption adjustment is executed. The center of the vertical axis frequency indicates a reference frequency f (for example, 50 Hz), the inner two of the upper and lower broken lines indicate non-adjustment frequency fluctuation widths Δf (for example, +0.18 Hz), and the outer two of the upper and lower broken lines indicate acceptable frequency fluctuation widths (for example, +0.2 Hz). The frequency of the electric power system exceeds the acceptable frequency fluctuation width when the electric current consumption adjustment is not executed. When an electric current consumption configuration is made, the electric current consumption adjustment is executed at more than the non-adjustment frequency fluctuation width Δf. The fluctuation of the frequency is suppressed in the range of not exceeding the acceptable frequency fluctuation width. Not to exceed the acceptable frequency fluctuation width, a temporal frequency for adjustment or the droop characteristics used for the adjustment illustrated in FIG. 2 is adequately set.

In the present First Embodiment, the adjustment method of the electric power consumption for adjusting the frequency of the system 101 is explained using the workloads and the air conditioning 114. Only any one of the workload and air conditioning may be used instead of using both the workload and air conditioning.

The electric power adjustment device 100 of the present First Embodiment can provide the adjustment capability for the frequency fluctuation of the system 101 without introducing new expensive facility and without executing useless electric power consumption adjustment.

### Second Embodiment

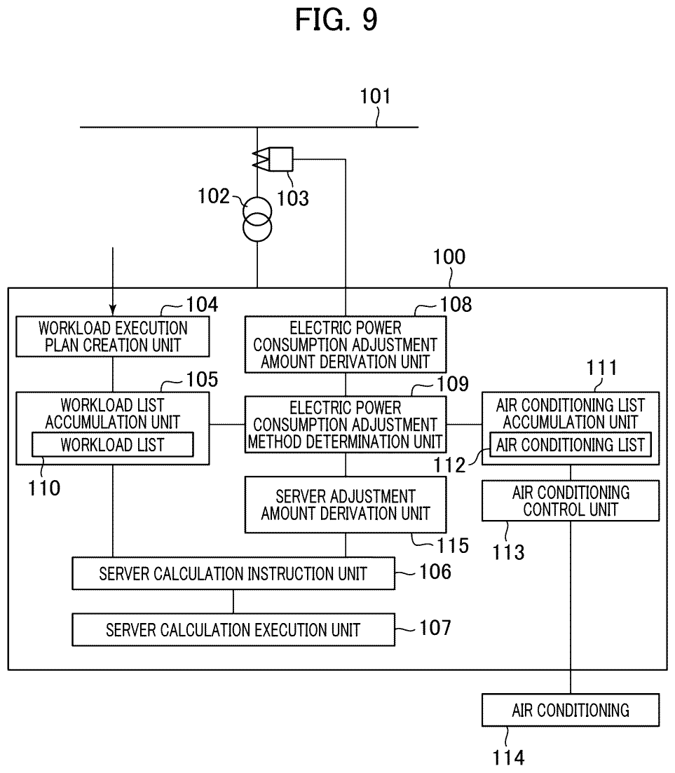

FIG. 9 illustrates a configuration diagram of the electric power adjustment device 100 of Second Embodiment of the present invention. In First Embodiment, some of the workloads executed by the server are paused or re-executed to adjust the electric power consumption of the server. In Second Embodiment, a clock frequency of a CPU provided in the server is changed to adjust the electric power consumption of the server. Therefore, while the electric power consumption of the server is adjusted by workload basis in First Embodiment, the electric power consumption of the server is adjusted by server basis in Second Embodiment.

In addition to the configuration explained in First Embodiment, the electric power adjustment device 100 of Second Embodiment includes a server adjustment amount derivation unit 115. First Embodiment describes the example in which the workloads executed by the server and the air conditioning are used for the electric power consumption adjustment. Second Embodiment explains only the electric power consumption adjustment of the server as a difference from First Embodiment. Note that, also in Second Embodiment, the electric power consumption adjustment may be made using both the server and the air conditioning or using only the server. The execution method for the workloads in the electric power adjustment device 100 and the adjustment method for the electric power consumption of the air conditioning are the same as in First Embodiment, and the adjustment method for the electric power consumption of the server is different. Hereinafter, a different point from First Embodiment is explained.

When (a) the electric power consumption adjustment is not during execution and (d) the electric power consumption adjustment amount is negative and the electric power consumption of the server is reduced, the clock frequency of the CPU used for calculation in the server is lowered to adjust the electric power consumption. The server that reduces the clock frequency of the CPU is selected from the servers in the descending order of the workload list 110. The change of the clock frequency of the CPU used by the server for calculation is limited. The rate of the electric power consumption reducible by the change of the clock frequency is set as the maximum electric power consumption rate. In the servers in the descending order of the workload list 110, the reducible electric power consumption is acquired in each server from the product of the sum of the electric power consumptions of the workloads during execution and the maximum electric power consumption rate. Until the reducible electric power consumption exceeds the required electric power consumption adjustment amount, the server used for the electric power consumption is selected. For example, when the electric power consumption adjustment amount is 10 kW, the electric power consumption reduction rate is 50%, and a workload execution plan is the list illustrated in FIG. 6, the adjustable electric power consumption in which the sum of the electric power consumptions of the servers No. 1 in the list is multiplied by the adjustable rate is 12.6 kW, and exceeds 10 KW of the electric power consumption adjustment amount. Therefore, the servers No. 1 are set as the electric power consumption adjustment servers. When the adjustable electric power consumption does not exceed the electric power consumption adjustment amount, the subsequent server is used for the electric power consumption adjustment in the descending order.

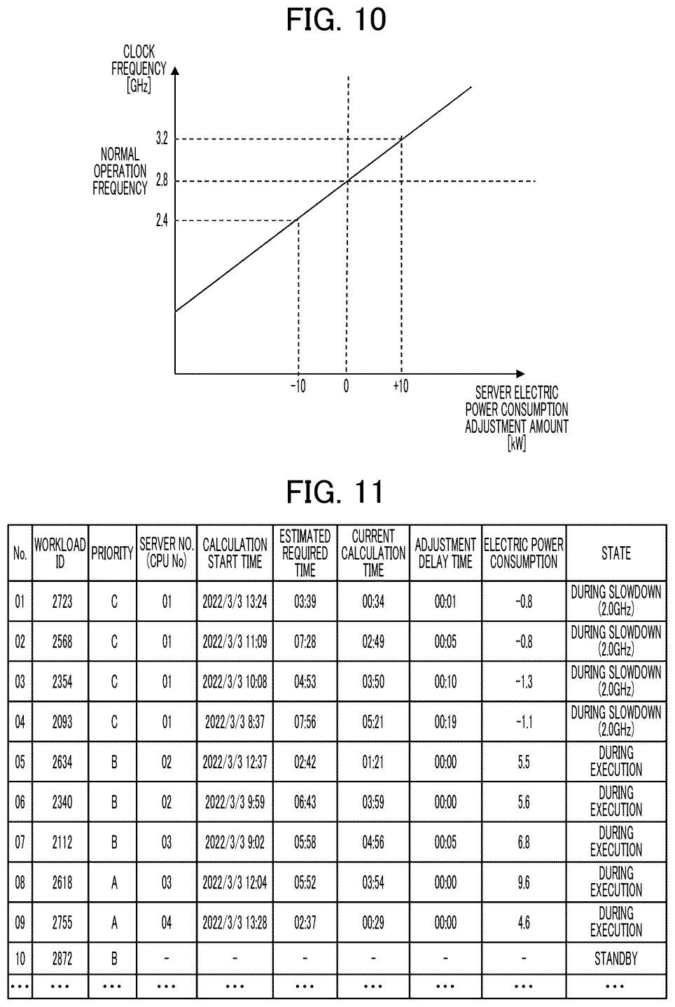

FIG. 10 illustrates one example of a relationship between a server electric power consumption adjustment amount and a clock frequency. In the server determined by the electric power consumption adjustment method determination unit 109, the server adjustment amount derivation unit 115 determines the clock frequency that satisfies the electric power consumption adjustment amount of the determined server. Since the relationship between the server electric power consumption adjustment amount and the clock frequency differs by the servers, data indicating the relationship between the server electric power consumption adjustment amount and the clock frequency are previously prepared for each server, and are stored, e.g., in the storage device provided in the electric power adjustment device 100. From the relationship between the server electric power consumption adjustment amount and clock frequency in the server that executes the electric power consumption adjustment, the clock frequency to be adjusted is determined. For example, when the server electric power consumption adjustment amount is-10 KW in FIG. 10, the clock frequency to be adjusted is set to 2.4 GHz.

In response to the determination of the server adjustment amount derivation unit 115, the server calculation instruction unit 106 transmits, to the server calculation execution unit 107, an instruction to the server that adjusts the electric power consumption to execute a change to the clock frequency determined by the server adjustment amount derivation unit 115. The server calculation execution unit 107 changes the clock frequency according to the instruction. The server calculation instruction unit 106 updates the workload list 110 after the change of the clock frequency.

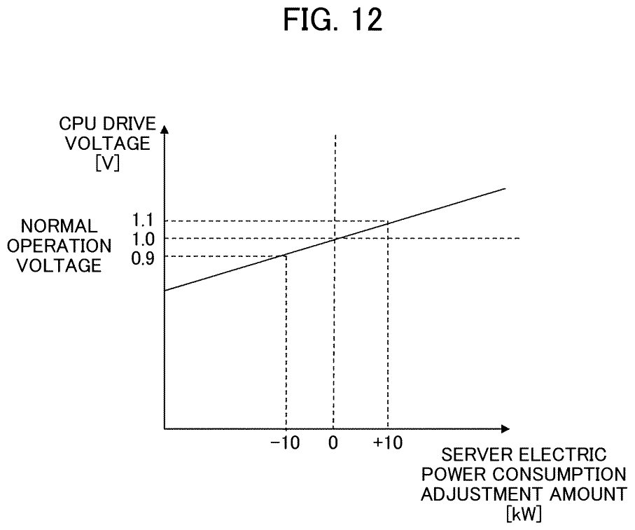

FIG. 11 illustrates the updated workload list 110 during execution of electric power adjustment. In response to the information from the server calculation instruction unit 106, the state column of the workload list 110 for the workload during execution at the server that adjusts the electric power consumption is set as during-slowdown. The clock frequency that has slowed down is also made to be known. Additionally, the reduction amount of the electric power consumption acquired as a result of the electric power consumption adjustment is inputted into the column of the electric power consumption of the workload list 110.

When (a) the electric power consumption adjustment is not during execution and (e) the electric power consumption adjustment amount is positive and the electric power consumption of the server is increased, the electric power consumption is adjusted by increasing the clock frequency of the CPU used for calculation of the server. As well as when the electric power consumption of the above server is reduced, the server that increases the clock frequency of the CPU is selected from the servers of the workload list 110 in the descending order. The rate of the electric power consumption that can be increased by changing the clock frequency is set as the maximum electric power consumption increase rate. In the servers in the workload list 110 in the descending order, an increasable electric power consumption in each server is determined from the product of the sum of the electric power consumptions of the workloads during execution in each server and the maximum electric power consumption increase rate. Until the increasable electric power consumption exceeds the required electric power consumption adjustment amount, the servers used for the electric power consumption adjustment are selected. When the adjustable electric power consumption does not exceed the electric power consumption adjustment amount, the subsequent server is used for the electric power consumption adjustment in the descending order.

As well as when the electric power consumption of the above server is reduced, in the server determined by the electric power consumption adjustment method determination unit 109, the server adjustment amount derivation unit 115 also determines the clock frequency that satisfies the electric power consumption adjustment amount of the determined server. For example, when the server electric power consumption adjustment amount is +10 KW in FIG. 11, the clock frequency to be adjusted is set to 3.2 GHz.

In response to the determination of the server adjustment amount derivation unit 115, the server calculation instruction unit 106 specifies the server that adjusts the electric power consumption, and sends an instruction to change to the clock frequency determined by the server adjustment amount derivation unit 115 to the server calculation execution unit 107. The server calculation execution unit 107 changes the clock frequency of the specified server. The server calculation instruction unit 106 updates the workload list 110 after the change of the clock frequency.

In response to the determination of the server adjustment amount derivation unit 115, the server calculation instruction unit 106 specifies the server that adjusts the electric power consumption, and sends an instruction to change to the clock frequency determined by the server adjustment amount derivation unit 115 to the server calculation execution unit 107. The server calculation execution unit 107 changes the clock frequency of the specified server. The server calculation instruction unit 106 updates the workload list 110 after the change of the clock frequency. The state column of the workload list 110 for the workload during execution at the server that adjusts the electric power consumption is set as during increasing speed. The clock frequency that has increased is also made to be known. Additionally, the increase amount of the electric power consumption acquired as a result of the electric power consumption adjustment is inputted into the column of the electric power consumption of the workload list 110.

(b) When the electric power consumption adjustment that reduces the electric power consumption is executed, the droop characteristics of A-A″ illustrated in FIG. 3 are used as well as in First Embodiment.

(d) When the value of the electric power consumption adjustment amount is negative, and the adjustment that reduces the electric power consumption of the server is executed, the clock frequency of the CPU of the server is reduced in the same way as above, and the electric power consumption of the server is reduced in reference to a workload list 110B. The server that reduces the clock frequency of the CPU is selected from the workload list 110 in the descending order. When there is already a workload during slowdown indicated in the workload list of FIG. 11, the reduced clock frequency does not reach the lower limit, and there is room for further reduction, the clock frequency of the CPU of the server is further reduced to reduce the electric power consumption. When the clock frequency reaches the lower limit and the electric power consumption adjustment amount has a remainder, the clock frequency of the CPU of the next lower server in the worklist is reduced with the same method. The workload list 110 is updated using the same method as above after the reduction of the clock frequency.

(e) When the electric power consumption adjustment amount is positive, and the adjustment that increases the electric power consumption of the server is executed, the electric power consumption adjustment that raises the clock frequency of the CPU in the server that is lower in the workload list 110 and during slowdown to increase the electric power consumption is made. When returning to the frequency in the normal operation, the adjustment to increase the electric power consumption of that server is ended. When the electric power consumption adjustments of all the servers during slowdown in speed are finished, a further adjustment is not executed, and the electric power consumption adjustment ends. After that, (a) the electric power consumption adjustment is executed using the droop characteristics having the offset of B-B′-A′-A when the electric power consumption adjustment is not during execution.

(c) When the electric power consumption adjustment that increases the electric power consumption is during execution, the droop characteristics of B-B″ illustrated in FIG. 3 are used as well as in First Embodiment.

(e) When the electric power consumption adjustment amount is positive, and the adjustment that increases the electric power consumption of the server is made, the clock frequency of CPU of the server is raised as above and the electric power consumption of the server is additionally increased in reference to the workload list 110. The server that raises the clock frequency of the CPU is selected from the workload list 110 in the descending order. When there is already the workload during increase in speed indicated in the workload list of FIG. 10, the increased clock frequency does not reach the upper limit, and there is room for further increase in speed, the clock frequency of the CPU of the server is further raised to increase the electric power consumption. When the clock frequency reaches the upper limit and the electric power consumption adjustment amount has a remainder, the clock frequency of the CPU is increased in the same method in the next lower server in the workload list. The workload list 110 is updated using the same method as above after the increment of the clock frequency.

(e) When the electric power consumption adjustment amount is positive, and the adjustment that reduces the electric power consumption of the server, the electric power consumption adjustment is executed to reduce the clock frequency of the CPU in the server that is lower in the workload list 110 and that is during increase in speed to reduce the electric power consumption. When returning to the frequency in the normal operation, the adjustment to increase the electric power consumption of that server is ended. When the electric power consumption adjustments of all the servers during increase in speed are finished, a further adjustment is not executed, and the electric power consumption adjustment is ended. After that, (a) the electric power consumption adjustment is executed using the droop characteristics B-B′-A′-A when the electric power consumption adjustment is not executed.

FIG. 12 illustrates one example of a relationship between a server electric power consumption adjustment amount and a CPU drive voltage. In the present Second Embodiment, the adjustment method for the electric power consumption using the clock frequency change of the CPU of the server is explained. Instead of the clock frequency, the drive voltage of the CPU may be changed. Both the clock frequency and the drive voltage may be changed. When the drive voltage is changed, the data of FIG. 12 is previously stored in, e.g., the storage device of the electric power adjustment device 100. In reference to the stored data as well as the data of FIG. 10, the drive voltage may be determined.

### Third Embodiment

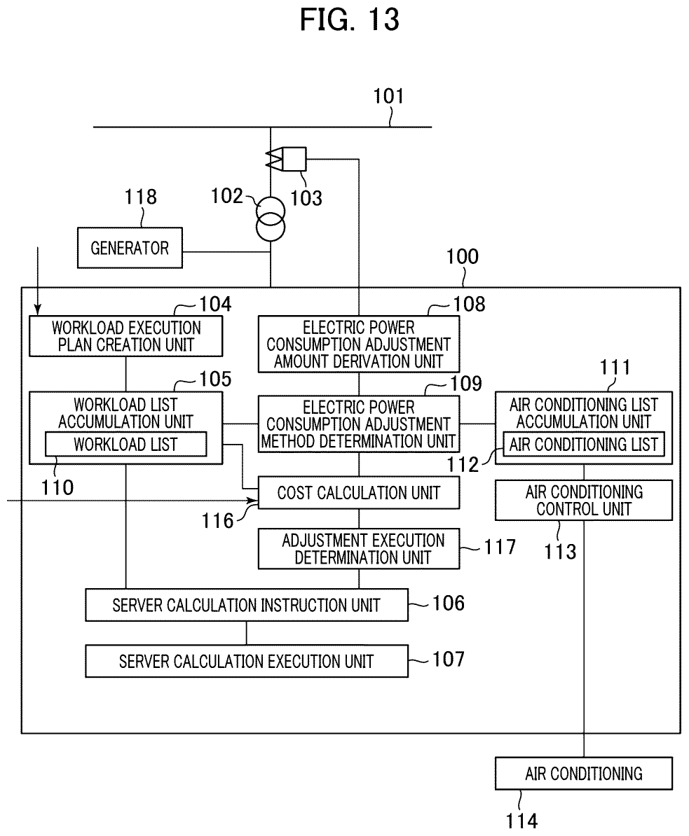

FIG. 13 illustrates a configuration diagram of the electric power adjustment device 100 of Second Embodiment of the present invention. In addition to the configuration explained in First Embodiment, the electric power adjustment device 100 in Third Embodiment includes a cost calculation unit 116, an adjustment execution determination unit 117, and a generator 118. The generator 118 can supply electric power to the data center and to the system. Thereby, the electric power consumption is adjusted in consideration of the cost, and the function providing the adjustment capability for a supply and demand adjustment market is added using the own generator 118. In the supply and demand adjustment market, the data center is a seller of the adjustment capability, and transmission system operators are buyers of the adjustment capability. The generator 118 may be a gas generator, a solar generator, or a wind generator. The solar generator and wind generator, whose power generation is irregular, may be used with storage batteries. The generator may be provided outside the site of the data center, and wheeling of generated electric power may be made using the system. Instead of the generator, electric power may be procured from a energy company. Also in First to Second Embodiments, the same generator 118 may be used. In Third Embodiment, an electric power procurement function and cost function using the generator 118 are added, a profit can be made by trades in the supply and demand adjustment market.

After the electric power consumption adjustment method determination unit 109 determines the method of an electric power consumption adjustment, the cost calculation unit 116 calculates (a) an amount of money earned by providing the adjustment capability to the supply and demand adjustment market when it is assumed that the electric power consumption adjustment is executed and (b) a reduction amount of a usage fee of an electric power consumption user for the workload in which the electric power consumption is adjusted. The amount of money earned by providing the adjustment capability to the supply and demand adjustment market is acquired from the supply and demand adjustment market, or estimated from the fluctuations of the solar power generation and wind power generation or the fluctuation of the demand. The amount of money of reduced usage fee of the electric power consumption user is determined by contract details, and calculated using information on the contract details. The adjustment execution determination unit 117 determines that the adjustment for the electric current consumption is executed when the former amount of money exceeds the latter amount of money, and determines that the adjustment for the electric current consumption is not executed when the former amount of money becomes less than the latter amount of money. The server calculation instruction unit 106 outputs an instruction of the adjustment for the electric current consumption when the adjustment execution determination unit 117 determines that the adjustment of the electric current consumption is executed. The server calculation execution unit 107 executes the same electric current consumption adjustment as First to Second Embodiments.

The power trading in the supply and demand adjustment market may be executed, for example, by accessing an electronic trading market by the cost calculation unit 116 by use of a specific trading protocol without requiring user operations. Alternatively, the user instructs the cost calculation unit 116 to execute trading, and the cost calculation unit 116 may execute the trading according to the instruction. As contents of trading, for example, the data center indicates, to a transmission system operator, that the supply and demand adjustment capability is provided, the transmission system operator indicates, on the market, that the operator purchases the capability, and the trading is completed. For example, the cost calculation unit 116 executes trading by transmitting, to the electronic trading market, the trading data of selling the adjustment capability and receiving, from the electronic trading market, the trading data of purchasing the adjustment capability.

### Modification of Present Invention

The above Embodiments explain that the electric power adjustment device 100 provides the frequency adjustment capability of the system 101. Other than the frequency adjustment capability of the system 101, the voltage adjustment capability of the system 101 also can be provided in the same method.

In the above Embodiments, the data center that provides the adjustment capability for the frequency fluctuation of the system 101 is explained. Also in a microgrid (in a specific geographical range, an electric power network configured using electric power facility using, e.g., solar cells or storage cells) other than the electric power system, the adjustment capability for the frequency fluctuation can be provided with the same technique. Since the frequency fluctuation occurs more frequently in the microgrid than in the system 101, the provided adjustment capability for the frequency fluctuation is more effective. Additionally, the adjustment capability for the voltage fluctuation other than the adjustment capability for the frequency fluctuation can be provided to the microgrid.

In the above Embodiments, each functional unit included in the electric power adjustment device 100 can be configured by hardware such as a circuit device implementing the each function or execution of software implementing the each function by use of an arithmetic unit such as a CPU.

### LIST OF REFERENCE SIGNS

100: electric power adjustment device
101: electric power system
102: transformer
103: frequency measurement unit
104: workload execution plan creation unit
105: workload list accumulation unit
106: server calculation instruction unit
107: server calculation execution unit
108: electric power consumption adjustment amount derivation unit
109: electric power consumption adjustment method determination unit
110: workload list
111: air conditioning list accumulation unit
112: air conditioning list
113: air conditioning control unit
114: air conditioning
115: erver adjustment amount derivation unit
116: cost calculation unit
117: adjustment execution determination unit
118: generator

1. An electric power adjustment device that adjusts an electric power consumption of at least any one of a computer group or an air conditioning device, comprising:
an adjustment amount calculation unit that calculates an adjustment amount of the electric power consumption of the computer group or air conditioning device on a basis of a frequency fluctuation in an electric power system;
a list storage unit that stores a list of at least any one of a workload executed by the computer group or the air conditioning device;
an adjustment object determination unit that determines an adjustment object whose electric power consumption is to be adjusted on a basis of the workload or air conditioning device described by the list and of the adjustment amount calculated by the adjustment amount calculation unit; and
an instruction unit that instructs the adjustment object determined by the adjustment object determination unit to adjust the electric power consumption.

2. The electric power adjustment device according to claim 1, wherein
the adjustment object determination unit repeats selection of the adjustment object until a total of the electric power consumptions adjusted by the adjustment object reaches the adjustment amount or no selectable adjustment object remains,
when the air conditioning device is a candidate of the adjustment object, the adjustment object determination unit determines whether the electric power consumption of the air conditioning device can be increased or reduced by comparing a temperature adjusted by the air conditioning device to a reference temperature, and determines whether to select the air conditioning device as the adjustment object in accordance with a result of the determination, and
when the temperature adjusted by the air conditioning device reaches an upper limit temperature, the adjustment object determination unit does not further reduce the electric power consumption of the air conditioning device.

3. The electric power adjustment device according to claim 1, wherein
the adjustment amount calculation unit previously defines droop characteristics between a frequency of the electric power system and the adjustment amount
the droop characteristics are such that the adjustment amount is configured to further reduce the electric power consumption of at least any one of the computer group or the air conditioner device as the frequency is lower when the frequency is less than a lower limit frequency,
the droop characteristics are such that the adjustment amount is configured to further increase the electric power consumption of at least any one of the computer group or the air conditioner device as the frequency is higher when the frequency is more than an upper limit frequency,
the droop characteristics are such that the adjustment amount is configured to become zero when the frequency is more than the lower limit frequency and less than the upper limit frequency and the electric power consumption adjustment is not executed, and
when the electric power consumption of at least any one of the computer group or the air conditioner device is adjusted by the adjustment amount, the adjustment amount calculation unit calculates the adjustment amount by referencing the droop characteristics by use of the frequency fluctuation.

4. The electric power adjustment device according to claim 1, wherein
the list lists the workloads in order from lower to higher in execution priority,
when the electric power consumption of the computer group is reduced by the adjustment amount, the adjustment object determination unit selects the workloads in order from lower to higher in the priority as the adjustment objects,
when the electric power consumption of the computer group is reduced by the adjustment amount, the adjustment object determination unit repeatedly selects the adjustment objects in order from lower to higher in the priority until a sum of the electric power consumptions by the workloads selected as the adjustment objects becomes more than the adjustment amount.

5. The electric power adjustment device according to claim 1, wherein
the list lists the workloads in order from lower to higher in execution priority,
when the electric power consumption of the computer group is increased by the adjustment amount, the adjustment object determination unit selects the workloads during pause or execution standby in order from higher to lower in the priority as the adjustment object and
when the electric power consumption of the computer group is increased by the adjustment amount, the adjustment object determination unit repeatedly selects the adjustment objects in order from higher to lower in the priority until a sum of the electric power consumptions by the workloads selected as the adjustment objects becomes more than the adjustment amount.

6. The electric power adjustment device according to claim 1, wherein
the list describes at least any one of the computer that executes the workloads or a processor that executes the workloads together with the workloads,
the adjustment object determination unit determines the computer that executes the workloads or the processor that executes the workloads as the adjustment object, and
when the computer or the processor executes a plurality of the workloads, the adjustment object determination unit determines the computer or the processor as the adjustment object to determine all the plurality of the workloads executed by the computer or the processor as the adjustment objects.

7. The electric power adjustment device according to claim 6, wherein
the instruction unit instructs the adjustment object to change a clock frequency or a drive voltage for an instruction to adjust the electric power consumption of the adjustment object.

8. The electric power adjustment device according to claim 7, wherein
the adjustment object determination unit calculates a electric power consumption of the computer or the processor, the electric power consumption being adjustable by changing the clock frequency or the drive voltage, and
the adjustment object determination unit repeats selection of the adjustment object until the calculated adjustable electric power consumption reaches the adjustment amount.

9. The electric power adjustment device according to claim 8, wherein
the list lists the workloads and the computers or processors that execute the workloads in order from lower to higher in execution priority,
the instruction unit increases the clock frequency or the drive voltage to increase the electric power consumption of the computer or processor,
the instruction unit reduces the clock frequency or the drive voltage to reduce the electric power consumption of the computer or processor,
when the electric power consumption of the computer group is reduced by the adjustment amount, the adjustment object determination unit determines the adjustment object from the computers or the processors in order from lower to higher in the priority, and
when the electric power consumption of the computer group is increased by the adjustment amount, the adjustment object determination unit determines the adjustment object from the computers or the processors in order from higher to lower in the priority.

10. The electric power adjustment device according to claim 9, wherein,
when the electric power consumption of the computer group is increased by the adjustment amount, the adjustment object determination unit determines the computer or the processor as the adjustment object in order from higher to lower in the priority until an upper limit of the clock frequency or drive voltage is reached,
when the electric power consumption of the computer group is increased by the adjustment amount, the adjustment object determination unit does not select the computer or processor that has reached the upper limit of the clock frequency or drive voltage as the adjustment object,
when the electric power consumption of the computer group is reduced by the adjustment amount, the adjustment object determination unit determines the computer or the processor as the adjustment object in order from lower to higher in the priority until the lower limit of the clock frequency or drive voltage is reached, and
when the electric power consumption of the computer group is reduced by the adjustment amount, the adjustment object determination unit does not select the computer or processor that has reached the lower limit of the clock frequency or drive voltage as the adjustment object.

11. The electric power adjustment device according to claim 10, wherein
when the electric power consumption of the computer group is increased by the adjustment amount and when the computer or processor in which the clock frequency or drive voltage can be increased is not present, the adjustment object determination unit starts execution of the workload by determining the workload during execution standby as the adjustment object, or increases the electric power consumption of the air conditioning device.

12. The electric power adjustment device according to claim 1, further comprising:
a cost calculation unit that calculates balance of payments acquired by adjusting the electric power consumption of the computer group; and
an adjustment execution determination unit that determines whether to adjust the electric power consumption of the computer group or air conditioning device on a basis of the balance of payments calculated by the cost calculation unit.

13. The electric power adjustment device according to claim 12, wherein
the cost calculation unit trades surplus electric power acquired by adjusting the electric power consumption of the computer group or air conditioning device on a supply and demand adjustment market.

14. The electric power adjustment device according to claim 1, further comprising a generator,
wherein the generator is constituted to supply electric power to the computer group or the air conditioning device.

15. The electric power adjustment device according to claim 1, wherein
the electric power system is a microgrid in which a distributed power generator supplies electric power in a specific area.
